(19) United States
(12) Patent Application Publication
(10) Pub. No.: US 2024/0415609 A1
(43) Pub. Date: Dec. 19, 2024

(54) GUIDED DENTAL SURGICAL ADAPTER WITH IMPROVED SURGICAL ADAPTABILITY TO PATIENT PHYSIOLOGY

(71) Applicant: EVOLLUTION IP HOLDINGS, INC., Birmingham, AL (US)

(72) Inventors: John J. BELLANCA, Birmingham, AL (US); Christian A. GEISSBERGER, Vestavia Hills, AL (US)

(21) Appl. No.: 18/742,636

(22) Filed: Jun. 13, 2024

Related U.S. Application Data
(60) Provisional application No. 63/508,193, filed on Jun. 14, 2023.

(51) Int. Cl. A61C 1/08; A61C 3/02

(52) U.S. Cl. CPC A61C 1/084; A61C 3/02

(57) ABSTRACT

Guided surgical implant systems, kits and methods including at least one guide adapter and at least one drill component removably connectable with the at least one guide adapter. The kit may include adapters, drills, taps and drivers of various sizes and can be provided for facilitating the guided surgery while permitting substantial interchangeability therebetween so as to accommodate in-surgery adjustment of a prescribed drilling protocol.

### CROSS-REFERENCE TO RELATED APPLICATIONS

This application claims priority to U.S. Patent Application Ser. No. 63/508,193 filed Jun. 14, 2023, the entirety of which is incorporated herein by reference.

### TECHNICAL FIELD

The present disclosure relates generally to the field of dental drills, and more particularly to a guided dental surgical adapter and a system and method for performing guided dental surgery.

### BACKGROUND

Guided dental surgeries use a combination of surgical guides, guide cylinders, and drill guide bodies to precisely locate drills used during oral osteotomies. Surgical guides are often custom manufactured to fit a patient's dental arch. Often a guide cylinder is placed within, or is attachable to, the custom surgical guide. The guide cylinders are used to direct the guide bodies during surgery. The guide bodies are generally either guide spoons that are completely separate from the drill or guide bodies that are fully integrated with the drill. The guide bodies themselves are typically sized such that their exterior diameter is the same as, or slightly smaller than, the guide cylinders within the surgical guide. Ordinarily, this means that only one guide body can be used with a given surgical guide and guide cylinder.

When the guide bodies are integrated with the surgical drills, there must be a set of drills of varying length and diameter for each diameter guide body and also the corresponding surgical guide and guide cylinder. Within each set, the maximum diameter of the drills is ordinarily fixed according to the diameter of the guide body. As such, a first drill set having a smaller diameter guide body than a second drill set will usually have a smaller maximum diameter drill than the second drill set. In such cases, a user may run into a scenario in which a drill is needed that has a larger diameter than in included within the set corresponding to the surgical guide. This typically requires the user to abandon the custom-made guide and continue using freehand drilling as a drill having a larger diameter, and therefore a larger guide body, which would not be compatible with the guide cylinder and surgical guide.

Accordingly, it can be seen that needs exist for a guided dental surgical adapter with improved surgical adaptability to patient physiology, and a system and method for performing guided dental surgery.

It is to the provision of a guided dental surgical adapter with improved surgical adaptability to patient physiology and a system and method for performing guided dental surgery meeting these and other needs that the present disclosure is primarily directed.

### SUMMARY

In example embodiments, provided is a guided surgical system and kit for permitting in-surgery adjustment of the drill protocol prescribed to a patient undergoing an osteotomy, for example, which may be used for the installation of an implant. Methods of using the system are also provided.

In one aspect, provided is a guided dental implant system including a drill, an adapter for receiving a portion of the drill, and a guide cylinder for constraining the position of the adapter relative thereto. In example embodiments, the adapter includes a guide body defining an external diameter and the guide cylinder includes an internal diameter, wherein the internal diameter of the guide cylinder is substantially similar or slightly larger than the external diameter of the guide body. According to example embodiments, the implant system may further include a surgical guide with the surgical guide configured for attachment of the guide cylinder thereto. Advantageously, the drill can be keylessly exchanged in the adapter during a procedure, rather than in the handpiece.

In another aspect, provided is a guided system for performing an osteotomy. The guided system includes at least one drill, at least one adapter for receiving a portion of the drill, and at least one guide cylinder for constraining the position of the adapter relative thereto. In example embodiments, the at least one adapter includes a guide body defining an external diameter and the guide cylinder defines an internal diameter, wherein the internal diameter of the guide cylinder is substantially similar or slightly larger than the external diameter of the guide body such that the guide body inserts into the guide cylinder without deflection. The coaxial and concentric arrangement of the components provides stability and prevents deflection of the drill. The adapter has a passive fit inside the guide cylinder.

In still another aspect, provided is a fully guided dental implant system for achieving an osteotomy. The implant system includes at least one guide adapter and a plurality of drills, wherein the plurality of drills include lengths and diameters of various sizes and are configured for interchangeable engagement with the at least one guide adapter. In example embodiments, the at least one guide adapter includes a tubular guide body for providing guidance to the guide adapter throughout the osteotomy regardless of the drill that is connected with the guide adapter.

In example embodiments, the system further includes a surgical guide and a guide cylinder connected to the surgical guide. In example embodiments, the tubular guide body is sized to provide a clearance or transition fit with the guide cylinder. In example embodiments, the at least one guide adapter includes two or more guide adapters, the two or more guide adapters including tubular guide bodies sized to provide for a clearance or transition fit with complementary sized guide cylinders.

In still another aspect, the adapter can be used as a keyless drill extender for freehand osteotomies, where the adapter converts a standard-length freehand drill into a keyless guided drill. Drills can be exchanged in the adapter rather than the handpiece. The fitted guide body receives the drill, simultaneously providing stability and guidance to the drill while allowing the drill to extend further from the handpiece. Advantageously, the systems provided herein can be operated as both guided and freehand surgical systems, reducing the need for separate tools.

These and other aspects, features and advantages of the systems and methods provided herein will be understood with reference to the drawing figures and detailed description herein, and will be realized by means of the various elements and combinations particularly pointed out in the appended claims. It is to be understood that both the foregoing general description and the following brief description of the drawings and detailed description of example embodiments are explanatory of example embodiments, and are not intended to be limiting, as claimed.

### BRIEF DESCRIPTION OF THE DRAWINGS

FIG. 1 shows a guided dental implant system according to an example embodiment.

FIG. 2 shows a perspective assembly view of the dental implant system of FIG. 1, showing a drill, an adaptor, and a cylinder.

FIG. 3 is a front plan view of the adapter of FIG. 2.

FIGS. 4-6 show front plan views of drill components usable with the guided dental implant system of FIG. 1.

FIG. 7 shows a plurality of adapters according to an example embodiment.

FIG. 8 shows a front plan view of a tissue punch according to an example embodiment.

FIG. 9 shows a front plan view of a guided implant driver according to example embodiments.

FIG. 10 shows a guide body insert having engagement features to engage a drill according to example embodiments.

FIG. 11 shows a cross-sectional view of the assembled dental implant system of FIG. 2, a guide body, and guide adapter insert engaged with a drill.

FIG. 12 shows an example sequence of use of the guided dental implant system or surgical kit according to an example embodiment.

### DETAILED DESCRIPTION OF EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

It must be noted that, as used in the specification and the appended claims, the singular forms “a,” “an,” and “the” include plural referents unless the context clearly dictates otherwise.

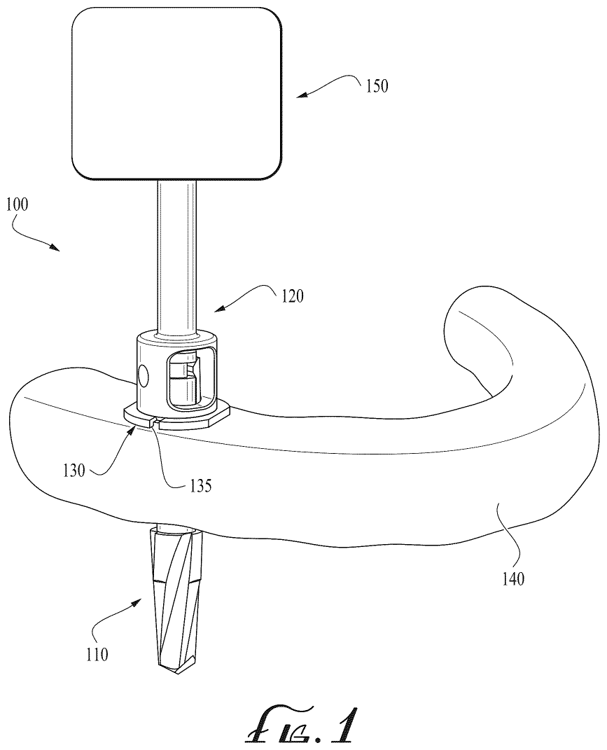

With reference now to the drawing figures, wherein like reference numbers represent corresponding parts throughout the several views, FIG. 1 shows an example embodiment of a guided surgical drill system 100. According to example embodiments, the guided surgical drill system 100 may comprise at least one drill component 110 and at least one adapter component 120. According to one example embodiment, a master or guide cylinder 130 may be configured to connect with a surgical guide 140 that comprises an impression of a patient's mouth, with the guide cylinder 130 being properly positioned at the drilling location, for example, to achieve an osteotomy.

As described in greater detail below, the guide cylinder can be provided in at least two sizes. In example embodiments, the size of the guide cylinder that is selected for attachment with the surgical guide 140 can influence the size of the adapter component that is to be used therewith. According to one example embodiment, guide cylinders can be provided in at least three sizes and the adapter components can be sized to complement the size of the guide cylinders, for example, such that the guide cylinders provide for a guided fit of the adapter components therein during the use thereof, in which the adapter movement is restricted to vertical movement. According to example embodiments, a clearance or transition fit is provided between the guide cylinder and the adapter component so as to facilitate axial alignment thereof while permitting for axial rotation during drilling, and for permitting for the insertion and removal therefrom depending on the state of the osteotomy and particular drill connected with the adapter component.

For example, according to example embodiments as described herein, the guided surgical drill system 100 may be comprised of a kit, or for example a complete guided surgical set to fulfil an osteotomy and implant installation, including drills beyond the scope of a particular prescribed drill protocol. For example, the in-surgery adjustment of the prescribed drill protocol, which may be required per the physiology of the patient (mostly in the form of bone density), permits any available drill of the set or kit to be utilized, regardless of whether the particular drill size is prescribed in the drill protocol. Thus, should the patient's physiology require in-surgery adjustment of the drill protocol, the removable attachment of any of the available drills with the adapter facilitates a wide range of adaptability, only limited by the implant diameter and the size of the guide cylinder embedded in the surgical guide. Accordingly, the prepared osteotomy can be customized for optimum surgical outcome without introducing delay and additional planning or having to resort to freehand approaches.

Furthermore, despite the size of the guide cylinder that is attached to the surgical guide 140 (according to the prescribed drill protocol) and the adapter that is complementary in size to the guide cylinder, any of the available drills included in the kit or available for use in the system can be removably connected and used with the adapter component. Accordingly, regardless of the adapter component that is chosen, any of the drills (regardless of drill head size) can be removably connected therewith if the drill head is complementary to the size of the guide cylinder of the surgical guide 140. In other words, all of the drill shanks can be fitted to any adapter, but the drill head size is limited to the size of the guide cylinder. Concerning surgical practicality, the diameter of the drill head will typically not exceed the diameter of the implant to be installed therein.

The guided surgical drill system 100 provides for a length-increasing osteotomy protocol, wherein each successive drill increases in length but not diameter to deepen the osteotomy. For example, for installing a 12 mm length implant, the standard protocol would begin with a predrill, followed by a 9 mm length drill and then a 12 mm length drill. Other implant systems, however, use a width increasing system in which the initial drill is drilled to the final depth (e.g. 12 mm) and then the diameter of the osteotomy is successively increased. Advantageously, the increasing drill length protocol described herein provides for stable, axial guidance throughout the procedure because the width of the drill and the guide therefore remains constant. Accordingly, lateral and angular deflection error between drills is removed.

According to an example use of the guided surgical drill system 100, a surgeon selects a desired drill 110 and connects it to an adapter 120. The adapter 120 connects to a driving device or handpiece 150 that rotates the combined adapter 120 and drill 110. During surgery, the drill 110 and adapter 120 are lowered into the guide cylinder 130 that is fitted within the surgical guide 140. Drill 110 passes through the cylinder 130 unimpeded. And before the drill 110 reaches the surface of the patient's tissue, adapter 120 begins to enter the cylinder 130, thereby providing guidance to the drill 110 while achieving the osteotomy. According to example embodiments, the diameter of the portion of the adapter 120 entering the guide cylinder 130 is substantially similar or slightly smaller than that of the guide cylinder 130, for example to provide the clearance or transition fit therebetween. In example embodiments, the similarity of diameters may assist in constraining the lateral movement of the combined adapter 120 and drill 110 so as to keep their combined vertical axes generally aligned with the vertical axis of the guide cylinder 130.

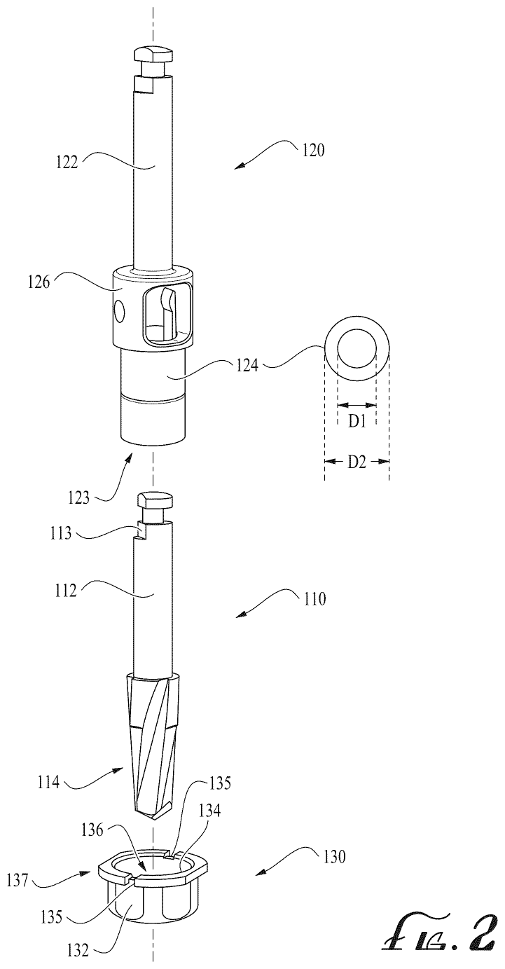

As shown in FIG. 2, the drill 110 has a drill shank 112 at its first end and a drill head 114 at its second end. The adapter 120 has a shank 122 at a first end, a tubular guide body 124 at a second end, and a stop portion 126 positioned therebetween. In example embodiments, the drill shank 112 is received within a receiver shaft 123 of the guide body 124 of the adapter 120 and removably engageable with one or more engagement features 128 on a guide adapter insert 129, where the guide adapter insert is immovably mounted within the receiver shaft 123, and which may be visible or accessible through a passageway or access window 127 formed with the stop portion 126 (see FIG. 3). Advantageously, only one size of adapter 120 and one size of guide adapter insert 129 are needed to engage all of the drill shanks in the system or kit.

In example embodiments, the guide adapter insert 129 is retained inside the guide body 124 via a press fit, such that the guide adapter insert 129 is permanently mounted inside the guide body 124. However, as can be envisioned by a person having ordinary skill in the art, the guide adapter insert 129 can be integrally formed with the guide body 124 through such as milling such that the engagement features 128 and the guide body 124 are a single piece. Alternatively, the guide adapter insert 129 can be affixed to the internal surface of the guide body 124 using affixing means such as screws, welds, or the like.

In example embodiments, the engagement features 128 comprise a pair of spring-based holders comprising ISO shank interfaces (also referred to as fingers), but may optionally comprise other alternative engagement features for removable engagement with the drill shank 112. The engagement features 128 removably engage with a groove or neck of the drill shank 112. The receiver shaft 123 is a straight internal channel to receive the drill; the drill and the internal channel of the adapter are coaxial such that when the drill is engaged in the adapter, the drill stably enters the bone. In the example embodiments shown in the drawings, the drill shank 112 includes a flattened portion 113 that rests on a corresponding ledge (not depicted) on the internal surface of the guide body 124 to prevent rotation of the drill within the adapter 120.

As can be envisioned by a person having ordinary skill in the art, the engagement features 128 are not limited to the spring-based fingers as depicted in the drawings. Alternative embodiments for retaining the drill shank 112 can include such as a snap ring feature, geometric features using friction, side pins, slide-in features from the side of the adapter, and the like.

Typically, the access window 127 permits visual confirmation that the drill shank 112 is properly engaged with the engagement features 128, and for example, may be configured for facilitating disengagement of the drill shank 112 therefrom when it is desired to remove the drill 110 from the adapter 120. In example embodiments, the length of drill shank 112 may comprise a sufficient length such that the drill head 114 does not come into contact with the tubular guide body 124 when the drill shank 112 is received within the tubular guide body 124. In other example embodiments, the length of the drill shank 112 can comprise a desired length. As depicted in FIG. 3, a stop surface 125 is provided on a lower side of the stop portion 126 and defines the contact surface that is engageable with an uppermost guide stop of the guide cylinder 130 to limit the extension of the drill and adapter within the guide. Advantageously, window 127 is a cutout that allows for visual confirmation of proper seating and securing of the drill. Additionally, the window allows for cleaning of the adapter, providing access to the internal guide body receiver shaft 123 from both ends, unlike a blind hole with access only from one end of the receiver shaft 123.

In various embodiments, the drill 110 can be disengaged from the adapter 120 by pulling downward, forcing the engagement features 128 to spring open to release the captured groove of the drill shank. During use, the drilling action applies rotational force to both the guide adapter and drill. The drilling action, axial guidance, rotation prevention by the ledge and pushing force applied to the drill prevents the drill from disengaging during use. Removing the drill from the osteotomy does not create force sufficient to disengage the drill. To remove the drill, the handpiece or guide adapter are held while applying a downward pulling force which exceeds the downward force caused by friction during drilling.

Still referring to FIG. 2, the guide cylinder 130 is sized to be configured for providing guidance to the tubular guide body 124. In example embodiments, the guide cylinder 130 comprises a body defining an external surface 132, an internal surface 134, and an opening 136 passing therethrough. In example embodiments, the opening 136 is at least large enough so as to permit the passage of the drill head 114 therethrough. According to example embodiments, a stop surface 125 of the stop portion 126 is configured to contact the top surface of an outermost collar of the guide cylinder 130 when the guide body 124 is fully inserted therein (see FIG. 1). In other words, the stop portion engages with a top surface of the guide cylinder to limit an amount of extension of the adapter and drill beyond the guide cylinder, limiting the depth to which the drill can enter the bone, in accordance with the pre-surgical planning protocol determined by the clinician. In general, the clinician will determine the implantation depth of an implant for a particular patient during the pre-surgical planning protocol. The surgical guide will then be planned and built with a given offset to match the system such that the guide cylinder is placed at a distance above the final planned position of the implant. In a particular embodiment, the offset of the guide cylinder top surface is 9.5 mm to match the stop portion surface 125, at which point the guide body is nested within the cylinder, thereby ensuring that the drill extends to the appropriate depth for the implant placement.

In example embodiments, the guide cylinder 130 is typically prepared for placement within the surgical guide 140 at a location of the osteotomy to be performed, and for example, the guide cylinder may be provided in three or more sizes to accommodate a wide range of patient physiology profiles.

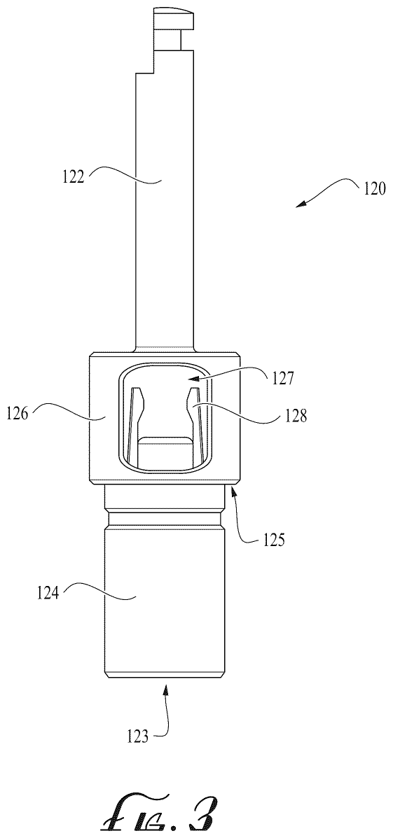

In example embodiments, the guided surgical drill system 100 comprises multiple adapters having varied external diameters, but a common internal diameter. In these embodiments, the system also comprises various drill components having drill heads of various lengths and diameters, but all having a drill shank with a diameter that is the same as, or slightly smaller than, the internal diameter of the adapters. For example, FIGS. 4-6 show various types of drill components that can be used with the guided surgical drill system 100. Because each adapter has a common internal diameter, any of the drill components can be used with any adapter, allowing for a universal drill set that is compatible with all of the adapters and guides in the system.

In a given set of an adapter and corresponding guide cylinder, the adapter comprises color coding corresponding to a color coding of the complementary sized guide cylinder. In some embodiments, additional instruments or implants can be color-coded to match the corresponding adapter and guide cylinder (e.g. tissue punches, implant drivers, extended shank drills, bone profiling burs, implants, and the like). Advantageously, the color-coding system allows for ease of use for clinicians and assisting personnel. For example, a clinician can ask assisting personnel to pass an adapter bearing a purple color to match the purple-coded guide cylinder being used in a procedure.

FIG. 4 shows a first drill component 112a comprising a pre-drill head 114a having a first diameter and a first length (e.g., 2.5 mm outer diameter and a length of 4.7 mm according to one example). In example embodiments, the first length is substantially minimal (e.g., 1 mm-5 mm according to one example embodiment), and for example, may be referred to as a predrill component to initiate the osteotomy. Subsequent drills of increasing length but having the same diameter (not shown) would then be used to deepen the osteotomy.

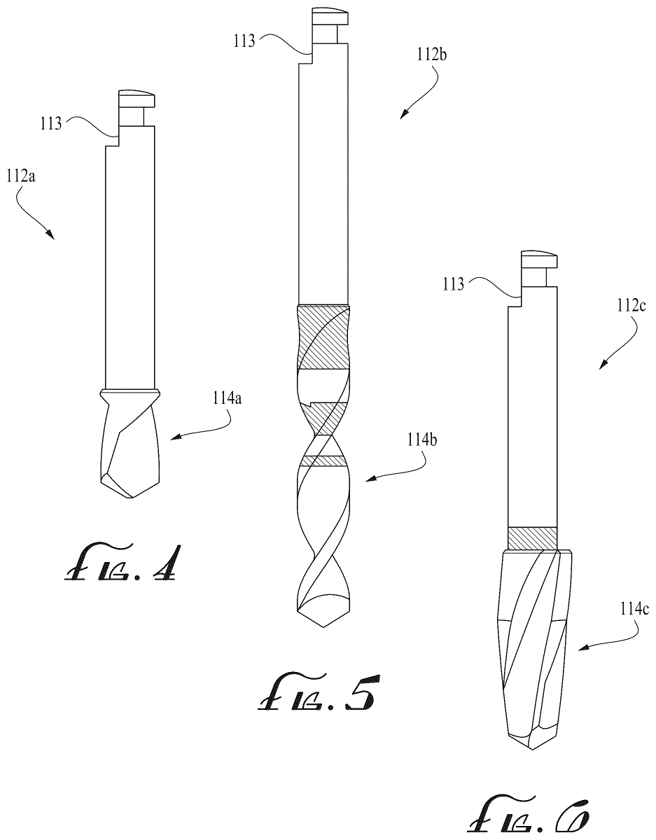

FIG. 5 shows an example of a second drill component 112b comprising a drill head 114b having the same diameter as the predrill shown in FIG. 4 (e.g., 2.5 mm×15 mm according to one example).

FIG. 6 shows an example of a drill component 112c. The depicted drill is for use in a creating wider osteotomy than the drills depicted in FIGS. 4 and 5. A typical protocol would also include a predrill and additional length drills having the same diameter (not depicted), based on the planned length implant. The drill component 112c shown has a drill head with a diameter of 3.7 mm an a length of 9 mm.

According to example embodiments, the drills 112a-c can comprise drill heads 114a-c of various lengths and diameters. For example, the drill heads 114a-c may comprise a length of between about 0.5-30 millimeters, for example between about 2.5-20 millimeters according one example embodiment. Drill heads 114a-c may comprise a diameter of between about 2-7.15 millimeters, for example about 2.5-6 millimeters according to one example embodiment. Preferably, the particular configuration, shape, and form of one or more cutting blades present at the drill head of the drill components can be chosen as desired.

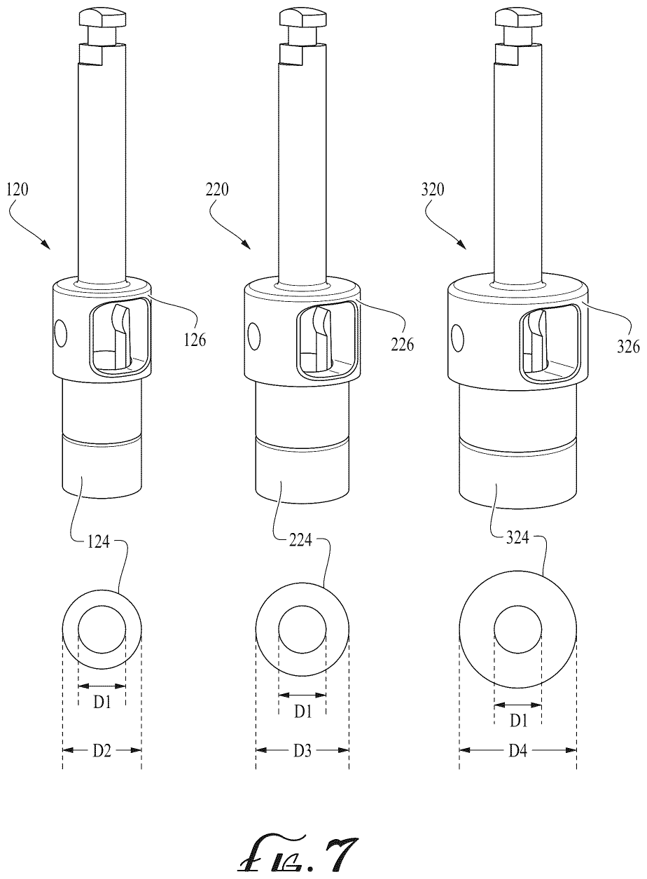

Referring to FIG. 7, the system 100 may comprise one or more adapters, all of which may be connected to the drill shanks 112a-c of the drills 110a-c. For example, the adapter can be sized according to the adapter 120, an adapter 220 or an adapter 320. According to example embodiments, the adapter's 120, 220, 320 respective cylindrical guide body 124, 224, 324 share a common internal diameter D1, but also have increasing external diameters D2, D3, and D4 respectively to mate with particular guide cylinder diameters. According to example embodiments, the diameter D1 is typically sized to receive the ISO standard drill shank diameter, for example, 2.4 mm, and the external diameters are between about 1 and about 10 mm according to example embodiments. According to one example embodiment, the external diameter can be between about 3.5 and about 6 mm. For example, according to the depicted example embodiments, D1 is about 2.4 mm, D2 is about 3.9 mm, D3 is about 4.7 mm, and D4 is about 5.9 mm.

Accordingly, according to some example embodiments, the adapter is selected based on the size of the guide cylinder that is attached to the surgical guide, which in turn may be defined by previous surgical planning. In example embodiments, the adapter and the guide can be color-coded, for example, to be able to easily distinguish tools of different sizes based on color. According to one example embodiment, a gray color represents the smallest size, a yellow color represents an intermediate size, and a purple color represents the largest size. As such, the guide cylinder can comprise like-colored indicators (gray, yellow, or purple depending on its size) to easily indicate to the surgeon the size of the adapter to be used for the guided surgery. In other embodiments, different colors may be used. In particular embodiments, a particular size may be indicated by the absence of color, for example, an adapter having no additional coloring may correspond to a guide cylinder that is either gray or has no additional coloring.

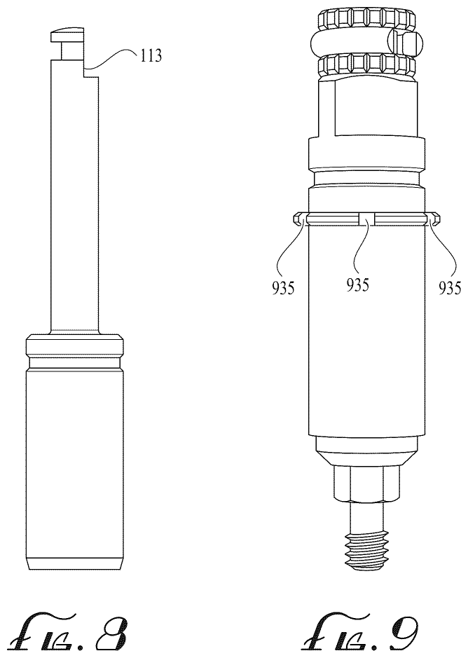

As shown in FIG. 8, a tissue punch may be provided to facilitate the initiation of the osteotomy prior to utilizing the predrill component. According to example embodiments, the tissue punch comprises a cylindrical guide body similar to that of the adapter, for example, which can similarly be sized to complement the guide cylinder of a particular size.

As depicted in FIG. 9, a guided implant driver can be provided for driving the implant into proper placement once an osteotomy is established. In example embodiments, the guided implant driver comprises a cylindrical guide body for receiving guidance by the guide cylinder when driving the implant during installation. Similarly, the guided implant driver may be provided in various sizes compatible for use with the any size guide cylinder. The implant driver can include a stop shoulder that includes notches 935. The notches 935 correspond to notches 135 in the collar of the guide cylinder 130. When the clinician inserts the implant, the notches 935 on the implant driver can be aligned with the notches 135 on the guide cylinder 130, ensuring correct alignment of the implant according to the surgical pre-planning protocol.

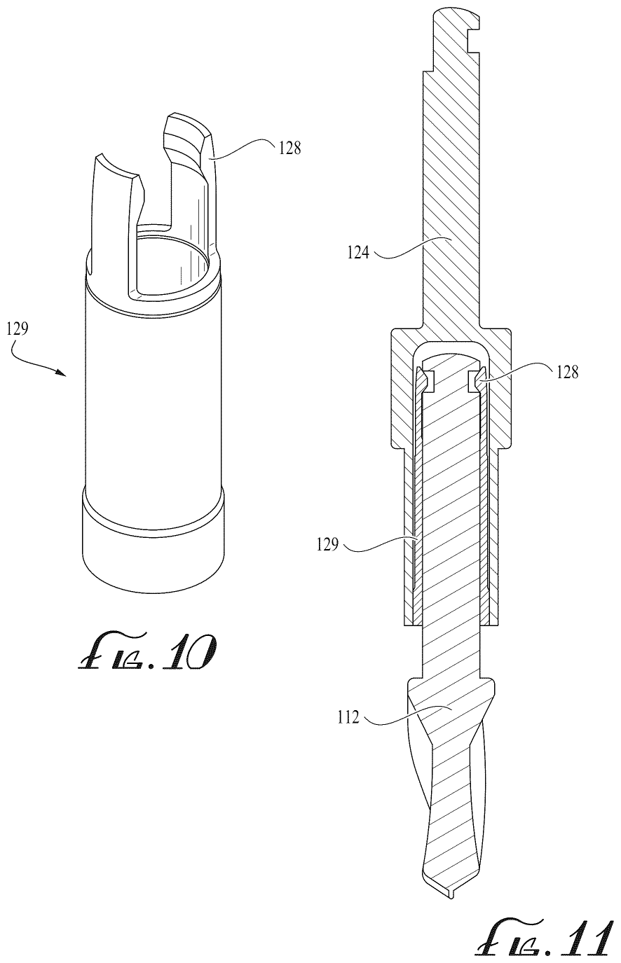

FIG. 10 shows an embodiment of guide adapter insert 129 having engagement features 128. Engagement features 128 engage with the neck of drill shank 112. The guide adapter insert 129 fits within guide body 124. Access window 127 can be used to visually confirm that the drill is properly seated within adapter and held by the engagement features 128.

In some embodiments, the adapter can be used with the drill for freehand surgery without the guide cylinder. In freehand surgery, the adaptor functions as a drill extender and a standard width-increasing drill protocol can be used for traditional implant placement. In specific embodiments, the smallest diameter drill is used with the adapter, thus allowing the use in confined spaces such as between close teeth. Use of the adapter for freehand surgery reduces the need for additional freehand tools, allowing clinicians to perform most osteotomies with the presently-described system alone. Advantageously, the quick-release ability provided by the engagement features allows for easier handling than traditional drill extenders. Also, traditional drill extenders typically are too long for use in molar regions, whereas the presently described adapter has a slimmer, shorter length that allows for ease of use in all regions of the mouth.

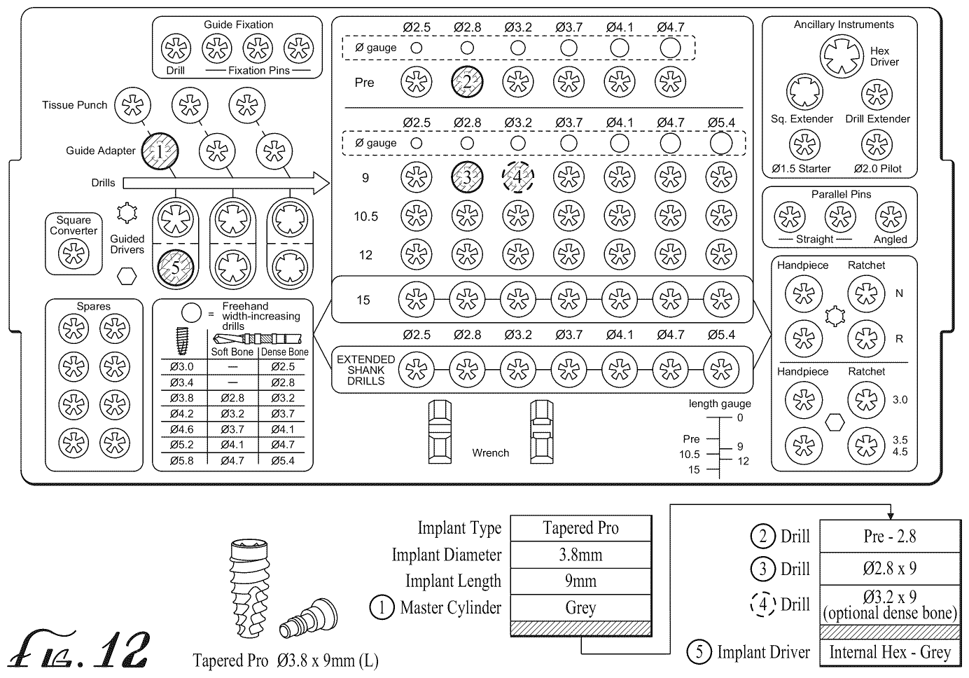

FIG. 11 shows a cross-sectional view of the guide adapter insert 129 inserted within the guide body 126. The engagement features 128 engage with the neck of drill 112 to hold the drill in place during use.

FIG. 12 shows an example method of a drill protocol and plan for the installation of an implant. For example, the implant to be installed can have an outer diameter of 3.8 mm and a length of 9 mm. According to the example, a surgical guide comprising a guide cylinder is obtained after performing surgical planning. In this example, the guide cylinder is the color grey, so the grey colored adapter will be used for each of the drilling steps of the drilling protocol as described herein.

At step 1, a pre-drill component is selected for attachment to the adapter to match the grey guide placed in the mouth of the patient, permitting the insertion of the pre-drill component within the guide cylinder. At step 2, drilling commences, contacting the bone of the patient to initiate the osteotomy. According to example embodiments, the pre-drill component comprises an outer diameter of 2.8 mm. At step 3, a drill having an outer diameter of 2.8 mm×9 mm in length is used, and optionally at step 4 a drill having a larger diameter of 3.2 mm×9 mm in length may be utilized in certain circumstances, for example, when the patient's physiology lends itself to dense bone where reducing the interference between the implant and osteotomy is desired. Thereafter, at step 5, a grey color-coded guided implant driver may be used for installing the implant in the osteotomy. According to example embodiments, regardless of the adapter's size (e.g., or color code), a plurality of different drills of various sizes may be used according to adjustments made to the drilling protocol in reaction to patient physiology.

FIG. 12 also shows an example embodiment of a kit including the drills and adapters described above. The kit can include drills of various gauges and lengths, as well as a set of adapters having different external guide body diameters. Additional components may also be included such as tissue punches, guide fixation pins, handpiece ratchets, implant drivers, pilot sleeves, and the like.

The systems and kits described herein can be used to perform osteotomies and to place dental implants. A method of performing an osteotomy can include surgical planning, manufacturing a guide comprising and a cylinder, and following a surgical protocol using the adapters and drills as described herein. The surgical protocol can include selecting an adapter that corresponds to a cylinder. The corresponding adapter and cylinder can be color coded for visual identification. The adapter is inserted into the handpiece. A first drill can be seated into the adapter by inserting the drill shank into the receiver shaft of the adapter until it is seated in the engagement features. Proper seating can be visually determined by looking in the access window. The drill and adapter can then be inserted into the cylinder. The drill should be advanced until the stop surface of the guide body meets the top surface of the guide cylinder. The drill can be removed and replaced with successive drills to achieve the desired depth and width appropriate for a desired implant according to the surgical protocol.

In some embodiments, the method can include using a tissue punch that corresponds to an adapter and cylinder, where the tissue punch is used prior to commencement of the osteotomy. Predrills or other cutting tools (e.g. bone levelers) can also be used with the adapter and cylinder for crestal clearance. Alternatively, burs can be engaged in the adapter for freehand crestal clearance or can be used without the adapter.

Once the appropriate osteotomy has been achieved for a particular implant, an implant driver can be engaged in the adapter and the adapter can be inserted through the cylinder to drive the implant to the appropriate depth. Like the drills, the stop surface of the adapter will ensure that the implant driver depth is controlled. A ratchet or handpiece can then be used to seat the implant through the cylinder.

To perform a freehand osteotomy, successive drills can be used in the adapter without the cylinder to guide the drill. The adapter provides additional length to the drill while providing additional stability over a drill connected directly to the handpiece. The implant can also be inserted using the implant driver connected to the adapter.

While the disclosure has been described with reference to example embodiments, it will be understood by those skilled in the art that a variety of modifications, additions and deletions are within the scope of the disclosure, as defined by the following claims.

What is claimed is:

1. A guided dental implant system comprising a drill, an adapter for keylessly receiving a portion of the drill, and a guide cylinder for constraining the position of the adapter relative thereto, the adapter comprising a guide body defining an external diameter and the guide cylinder comprising an internal diameter, wherein the internal diameter of the guide cylinder is substantially similar to or slightly larger than the external diameter of the guide body such that the guide body inserts into the guide cylinder without deflection.

2. The guided dental implant system of claim 1, wherein the guide body comprises engagement features to removably receive the drill.

3. The guided dental implant system of claim 2, wherein a stop portion of the guide body further comprises an access window through which proper engagement of the drill with the engagement features is visible.

4. The guided dental implant system of claim 1, wherein the adapter comprises a straight internal channel to receive the drill and wherein the drill, the adapter and internal channel thereof, and the guide are coaxial such that when the drill is engaged in the adapter the drill enters the guide cylinder without deflection.

5. The guided dental implant system of claim 1, further comprising a plurality of drills, each drill having the same diameter shank.

6. The guided dental implant system of claim 1, wherein the guide body comprises:
a stop portion, wherein the stop portion engages with a top surface of the guide cylinder to limit an amount of extension of the adapter and drill beyond the guide cylinder; and
an internal ledge, wherein the ledge interacts with a flat portion of a drill shank to limit rotation of the drill once the drill is seated within the guide adapter.

7. The guided dental implant system of claim 1, further comprising a surgical guide, the surgical guide configured for attachment of the guide cylinder thereto.

8. A system for performing an osteotomy, the guided system comprising at least one drill and at least one adapter for keylessly receiving a portion of the drill, wherein the adapter comprises a stop portion comprising a pair of spring-biased engagement features to removably receive the drill, wherein the adapter is a drill extender.

9. The system of claim 8, wherein the guide body comprises a guide adapter insert fitted therein, the guide adapter insert comprising the pair of spring-biased engagement features.

10. The system of claim 9, wherein a stop portion of the guide body further comprises an access window through which proper engagement of the drill with the engagement features is visible.

11. The system of claim 8, wherein the adapter comprises a straight internal channel to receive the drill and wherein the drill, adapter, and the internal channel of the adapter are coaxial such that when the drill is engaged in the adapter the drill stably enters bone.

12. A fully guided dental implant system for achieving an osteotomy, the implant system comprising at least one guide adapter and a plurality of drills, the plurality of drills comprising lengths and diameters of various sizes and being configured for interchangeable engagement with the at least one guide adapter, the at least one guide adapter comprising a tubular guide body for providing guidance to the guide adapter throughout the osteotomy regardless of the drill that is connected with the guide adapter.

13. The fully guided dental implant system of claim 12, further comprising a surgical guide and a guide cylinder connected to the surgical guide.

14. The fully guided dental implant system of claim 13, wherein the tubular guide body is sized to provide a clearance or transition fit with the guide cylinder.

15. The guided dental implant system of claim 12, wherein the guide body comprises a guide adapter insert fitted therein, the guide adapter insert comprising engagement features to removably receive the drill.

16. The guided dental implant system of claim 15, wherein a stop portion of the guide body further comprises an access window through which proper engagement of the drill with the engagement features is visible.

17. The guided dental implant system of claim 12, wherein the adapter comprises a straight internal channel to receive the drill and wherein the drill, the internal channel of the adapter, and the guide are coaxial such that when the drill is engaged in the adapter the drill enters the guide cylinder without deflection.

18. The guided dental implant system of claim 12, wherein the guide body comprises:
a stop portion, wherein the stop portion engages with a top surface of the guide cylinder to limit an amount of extension of the adapter and drill beyond the guide cylinder; and
an internal ledge, wherein the ledge interacts with a flat portion of a drill shank to limit rotation of the drill once the drill is seated within the guide adapter.

19. The fully guided dental implant system of claim 12, wherein the system comprises two or more guide adapters, the two or more guide adapters comprising tubular guide bodies having external diameters sized to have a transition fit with complementary sized guide cylinders.

20. The fully guided dental implant system of claim 19, wherein the each of the at least one adapters comprises color coding corresponding to a color coding of a complementary sized guide cylinder.
